(19) United States
(12) Patent Application Publication
(10) Pub. No.: US 2019/0046840 A1
(43) Pub. Date: Feb. 14, 2019

(54) PORTABLE SELF-ADJUSTING UNDERWATER BOOSTER WITH A LIFE-SAVING DEVICE

(71) Applicant: Kin Wai LAU, Hong Kong (HK)

(72) Inventor: Kin Wai LAU, Hong Kong (HK)

(21) Appl. No.: 15/706,997

(22) Filed: Sep. 18, 2017

(30) Foreign Application Priority Data
Aug. 10, 2017 (CN) 201710681101.3

(51) Int. Cl. A63B 35/08; B63C 11/02; B63C 9/15; B63H 11/12; B63H 23/02; G05D 7/06

(52) U.S. Cl. CPC A63B 35/08; B63C 11/02; G05D 7/0682; B63H 11/12; B63H 23/02; B63C 9/15

(57) ABSTRACT

The invention relates to a portable self-adjusting underwater booster with a life-saving device which includes a belt, a life-saving device and a propulsion device. The belt includes a rear end of the belt and a front end of the belt. A fastener is provided on the front end of the belt. The fastener is used to fasten the belt. The rear end of the belt is provided with a mounting plate, a first bag and a second bag at outer side. The mounting plate is provided with a connecting hole and an arc groove at outer side. The arc groove is provided with an arc rack. The life-saving device includes a compressed gas tank disposed in the second bag, a valve, and an airbag. The airbag is fixedly connected to the belt. The propulsion device includes an upper cylinder and a lower cylinder. The portable self-adjusting underwater booster with a life-saving device has advantages of having simple and reasonable structure, being convenient to use, safe and reliable, high degree of intelligence with life-saving device. It effectively solves the problem regarding the existing underwater boosters not having life-saving function.

### FIELD OF THE INVENTION

The invention relates to diving equipment, and more particularly to a portable self-adjusting underwater booster with a life-saving device.

### BACKGROUND

Diving is to carry out underwater activities with or without professional devices such as underwater exploration, salvage, reparation, and underwater works. Later, diving gradually developed into underwater leisure activities that can achieve the purpose of exercise, and entertainment. Diving requires the cooperation of arms and legs to maintain a gesture or move in the water, which requires diving personnel to have a strong physical strength and endurance as a basis. Although there are boosters for diving in the art, those boosters have complicated structure with large size and difficult to operate and expensive. The professional divers go through a long time of training and thus have good physical strength, endurance and experience, but long hours of underwater operations on the body's physical burden are still great. In addition, the existing diving equipment are not provided with life-saving device. Once the accidence happens, the consequences would be disastrous. In view of this, it is desirable to develop an underwater booster with life-saving device that has a simple structure and is easy to operate.

### SUMMARY OF THE INVENTION

The technical problem to be solved is to overcome the above-mentioned deficiency by providing a portable self-adjusting underwater booster with a life-saving device which has advantages of having simple and reasonable structure, being convenient to use, safe and reliable, high degree of intelligence with life-saving device. It effectively solves the problem regarding the existing underwater boosters not having life-saving function.

The technical solution is to provide a portable self-adjusting underwater booster with a life-saving device which includes a belt, a life-saving device, and a propulsion device. The belt includes a ring-shaped rear end of the belt made of link boards, and a front end of the belt made of straps. The front end of the belt is fixedly connected to two ports of the rear end of the belt. The front end of the belt is provided with a fastener that fastens the belt.

The rear end of the belt is symmetrically provided with a chute at the inner side. The chute is caught in an arc plate, and the arc plate is slidably connected to the chute. The chute is provided with a tension sensor. The arc plate is provided with a cam shaft at the inner side. The cam shaft is connected to the tension sensor by a first spring. The rear end of the belt is symmetrically provided with mounting plates at left and right outer side. The rear end of the belt is provided with a first bag and a second bag.

The mounting plate is provided with a plurality of indentations at the inner side. The rear end of the belt is provided with a plurality of protrusions. The protrusion is provided with a second spring that extends into the indentation. The mounting plate presses the second spring so that the protrusion is fixedly connected with the mounting plate by a first pin. The mounting plate is provided with a connecting hole and an arc groove at outer side. One inner side of the arc groove is provided with an arc rack. The other inner side of the arc groove is provided with a rubber gasket for collision prevention.

The life-saving device includes a compressed gas tank disposed in the second bag, a valve, and an airbag disposed in the inter layer of the rear end of the belt. The airbag is fixedly connected to the belt. The valve includes a housing, an inlet, an outlet, a sealing partition, a slider that is disposed in the cavity of the housing and slidably connects to the housing, and a pipe fixedly disposed on the slider. The inlet is screwed to the compressed gas tank. The outlet connects to the airbag. The pipe is provided with a third spring. Two ends of the third spring are in contact with the slider and the housing respectively. The slider presses the third spring such that the slider fastens the housing by a second pin.

The propulsion device includes an upper cylinder and a lower cylinder. The upper cylinder is provided with a shaft that is rotatably connected with the connecting hole. The top end of the upper cylinder is provided with a filter. The inner cavity of the upper cylinder is provided with a first motor with a propeller. The bottom end of the upper cylinder is provided with a second motor. The second motor is driven to connect with the arc rack by a gear. The lower cylinder is composed of a plurality of sleeves. The top end of the lower cylinder is fixedly connected to the upper cylinder. The bottom end of the lower cylinder is connected to the mounting plate by an electric vat.

Further, the first pin is arc-shaped.

Further, the first bag is provided with a battery and a micro controller.

Further, the micro controller electrically connects to the batter, the tension sensor, the first motor, the second motor, and the electric vat, respectively.

Further, the lower cylinder is provided with a first gyroscope and a water pressure sensor. The first gyroscope and the water pressure sensor are respectively electrically connected to the micro controller.

Further, the top end of the upper cylinder is provided with a protective cover made of screen.

Further, the lower cylinder is composed of a plurality of sleeves. The outside of the top end of the sleeves is provided with an outer convex ring. The inner side of the end of the sleeves is provided with an inner convex ring. The adjacent two sleeves are set to each other. The outer convex ring is in contact with the inner convex ring.

Further, the fastener is provided with a second gyroscope electrically connected to the micro controller.

Further, two ends of the electrical vat are hinged to the bottom end of the lower cylinder and the mounting plate, respectively.

The technical effect of the invention is to provide a portable self-adjusting underwater booster with a life-saving device which includes a belt, a life-saving device and a propulsion device. The belt fixes to the waist of the human body. The life-saving device and the propulsion device are connected to the belt. The life-saving device can pull the second pin to allow the gas to enter the airbag and generate buoyancy to drag the body out of the water. The belt is provided with a mounting plate. The propulsion device is installed on the mounting plate. Activities in multiple directions can be achieved by the driving of the second motor and the electrical vat. It can achieve the thrust that is exerted on the human body in multiple directions. The mounting plate and the belt are fixedly connected by the first pin. When emergency happens, the first pin can be pulled out to abandon the propulsion device. The arc plate in the inner side of the belt connects to the tension sensor, and transmits the signal of relative rotation to the micro controller. The second gyroscope detects the inclination angle of the human body. The first gyroscope is used to detect the rotation angle of the propulsion device relative to the human body. The water pressure sensor is used to detect the dive depth in order to avoid the danger caused by deep diving. The device has advantages of having simple and reasonable structure, being convenient to use, safe and reliable, high degree of intelligence with life-saving device. It effectively solves the problem regarding the existing underwater boosters not having life-saving function.

### BRIEF DESCRIPTION OF THE DRAWINGS

The invention is illustrated by the following figures and embodiments.

FIG. 1 shows a schematic diagram of whole structure of a portable self-adjusting underwater booster with a life-saving device in accordance with an example embodiment.

FIG. 2 shows a longitudinal profile of schematic diagram of the connection of an arc plate and a belt for a portable self-adjusting underwater booster with a life-saving device.

FIG. 3 shows a horizontal profile of schematic diagram of the connection of the arc plate and the belt for a portable self-adjusting underwater booster with a life-saving device.

FIG. 4 shows a schematic diagram of a belt, a first bag and a second bag of a portable self-adjusting underwater booster with a life-saving device.

FIG. 5 shows a schematic diagram of the connection of a mounting plate and a propulsion device for a portable self-adjusting underwater booster with a life-saving device.

FIG. 6 shows a schematic diagram of a mounting plate of a portable self-adjusting underwater booster with a life-saving device.

FIG. 7 shows a schematic diagram of a propulsion device of a portable self-adjusting underwater booster with a life-saving device.

FIG. 8 shows schematic diagram of a valve of a portable self-adjusting underwater booster with a life-saving device.

The reference numbers of the figures are as follows: 1: belt; 11: rear end of the belt; 111: protrusion; 112: second spring; 113: chute; 12: front end of the belt; 13: fastener; 14: arc plate; 141: cam shaft; 142: first spring; 143: tension sensor; 15: mounting plate; 150: arc groove; 151: first pin; 152: indentation; 153: rubber gasket; 154: connecting hole; 155: arc rack; 16: first bag; 17: second bag; 2: life-saving device; 21: airbag; 22: compressed gas tank; 23: valve; 230: housing; 231: second pin; 232: inlet; 233: outlet; 234: sealing partition; 235: slider; 236: pipe: 237: third spring; 3: propulsion device; 31: protective cover; 32: upper cylinder; 321: filter; 322: first motor; 323: shaft; 324: second motor; 325: gear; 33: lower cylinder; 34: electrical vat; 35: battery; 36: micro controller; 37: first gyroscope; 38: water pressure sensor.

### DETAILED DESCRIPTION

The invention is illustrated in accordance with figures. The figures as simplified diagrams demonstrate the basic structures of the apparatus of embodiments of the invention. Thus, the invention is not limited to the figures.

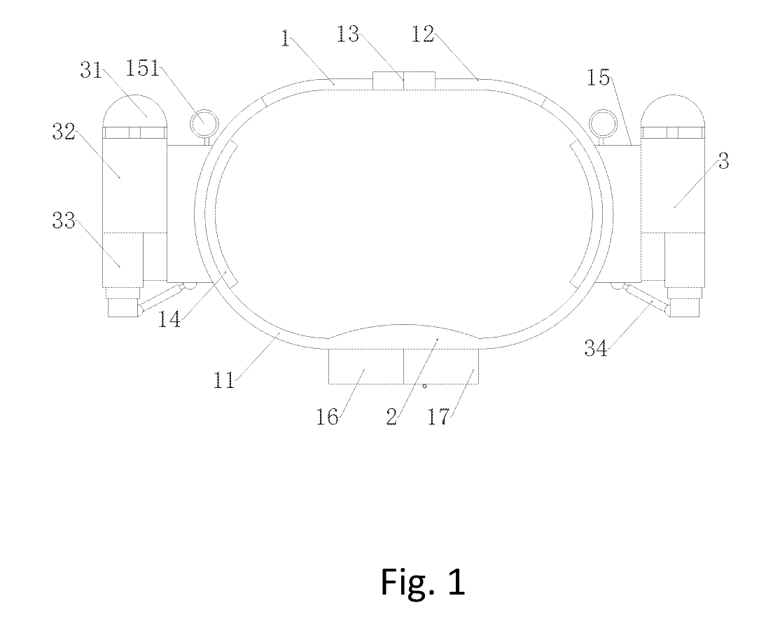

As shown in FIG. 1, a portable self-adjusting underwater booster with a life-saving device includes a belt 1, a life-saving device 2, and a propulsion device 3. The belt 1 includes a ring-shaped rear end 11 of the belt made of link boards, and a front end 12 of the belt made of straps. The front end 12 of the belt is fixedly connected to two ports of the rear end 11 of the belt. The front end 12 of the belt is provided with a fastener 13 that fastens the belt.

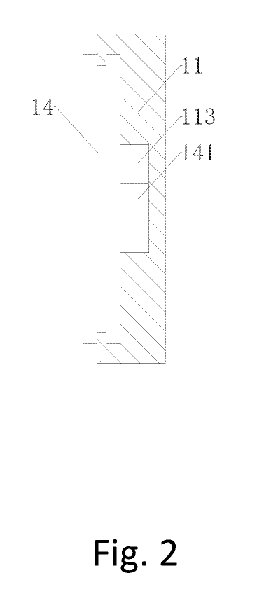

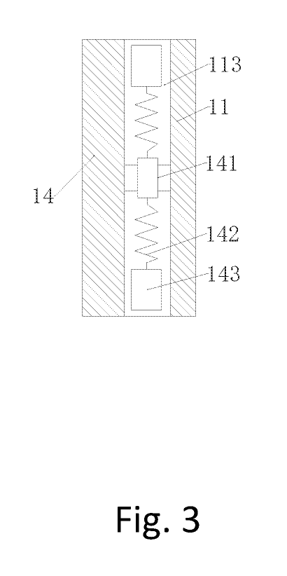

As shown in FIGS. 1, 2, and 3, the rear end 11 of the belt is symmetrically provided with a chute 113 at the inner side. The chute 113 is caught in an arc plate 14, and the arc plate 14 is slidably connected to the chute 113. The chute 113 is provided with at least two tension sensors 143 for detecting the force in the opposite direction. The arc plate 14 is provided with a cam shaft 141 at the inner side. The cam shaft 141 is connected to the tension sensor 143 by a first spring 142. In an example embodiment, there is only one arc plate 14 at the inner side of the belt. In another example embodiment, a plurality of arc plates 14 are disposed at the inner side of the belt. In another example embodiment, another strap that is fixed to the human body replaces the arc plate to connect with the tension sensor.

The rear end 11 of the belt is symmetrically provided with mounting plates 15 at left and right outer side. The rear end 11 of the belt is provided with a first bag 16 and a second bag 17. The first bag 16 is provided with a batter 35 and a micro controller 36.

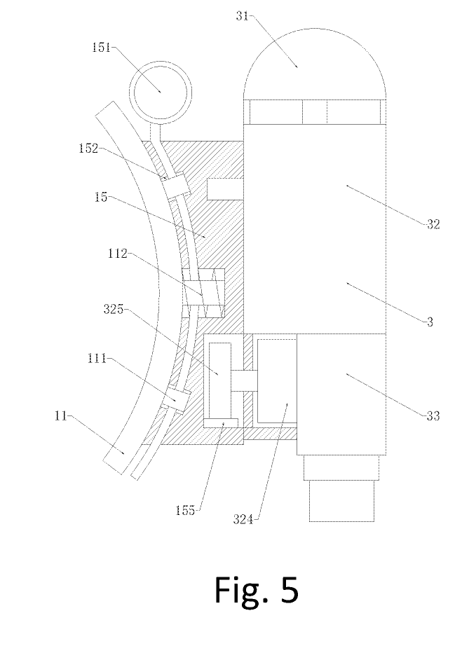

As shown in FIG. 5, the mounting plate 15 is provided with a plurality of indentations 152 at the inner side. The rear end 11 of the belt is provided with a plurality of protrusions 111. The protrusion 111 is provided with a second spring 112 that extends into the indentation 152. The mounting plate 15 presses the second spring 112 so that the protrusion 111 is fixedly connected with the mounting plate 15 by a first pin 151. The first pin 151 is arc-shaped. The first pin 151 is made from rigid material to avoid the deformation of the first pin 151 which will affects the drawing out.

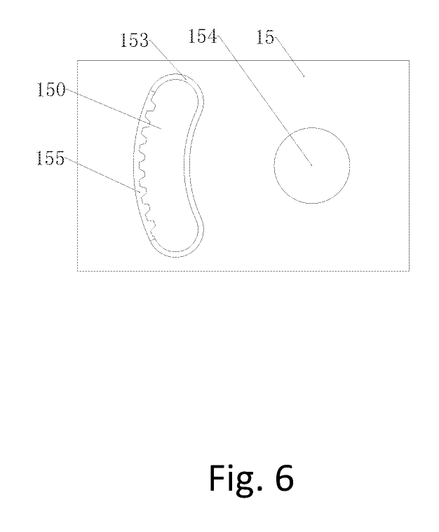

As shown in FIG. 6, the mounting plate 15 is provided with a connecting hole 154 and an arc groove 150 at outer side. One inner side of the arc groove is provided with an arc rack 155. The other inner side of the arc groove 150 is provided with a rubber gasket 153 for collision prevention. The rubber gasket 153 may also be made of other material having a certain elasticity and can function as a cushion in a collision between the components.

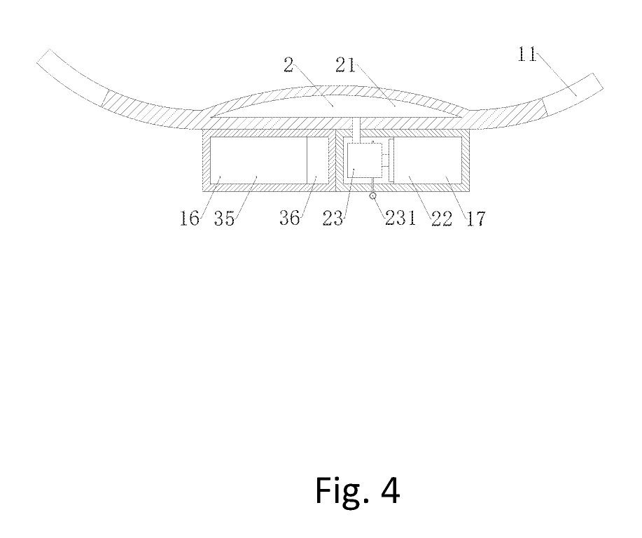

As shown in FIG. 4, the life-saving device 2 includes a compressed gas tank 22 disposed in the second bag, a valve 23, and an airbag 21 disposed in the inter layer of the rear end 11 of the belt. The airbag 21 is fixedly connected to the belt 1. The medium that connects the airbag 21 with the belt 1 may be flexible materials such as chain, rope, etc.

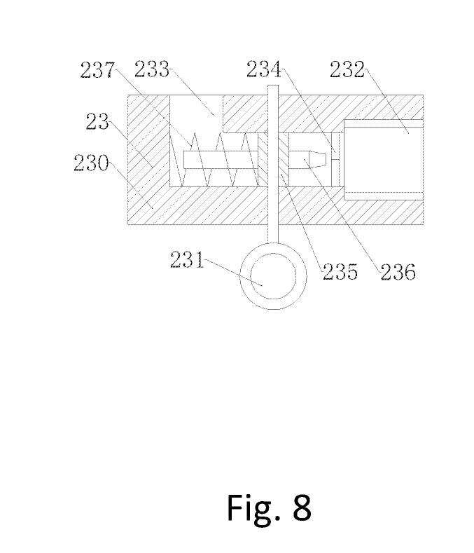

As shown in FIG. 8, the valve 23 includes a housing 220, an inlet 232, an outlet 233, a sealing partition 234, a slider 230 that is disposed in the cavity of the housing 230 and slidably connects to the housing 230, and a pipe 236 fixedly disposed on the slider 235. The inlet 232 is screwed to the compressed gas tank 22. The outlet 233 connects to the airbag 21. The pipe 236 is provided with a third spring 237. Two ends of the third spring 237 are in contact with the slider 235 and the housing 230, respectively. The slider 235 presses the third spring 237 such that the slider 235 fastens the housing 230 by a second pin 231.

In an example embodiment, the sealing partition 234 is preformed by the sealing material and is put into the air valve 23d during use. The sealing partition 234 is pressed towards the valve 23 by the compressed gas tank 22. In another example embodiment, the sealing partition 234 is directly fixed to the inlet 232 of the valve 23.

In an example embodiment, the compressed gas tank 22 has an inflation port and an outlet 233. After the outlet 233 of the compressed gas tank 22 is threadedly connected to the inlet 232 of the valve 23, the compressed gas tank 22 is inflated by the inflation port of the compressed gas tank 22. In another example embodiment, the compressed gas tank 22 has a predetermined push-type air switch. The outlet 233 of the compressed gas tank 22 is threadedly connected to the intet 232 of the valve 23, which will trigger the air switch, and thereby the compressed gas tank 22 provides gas to the externals.

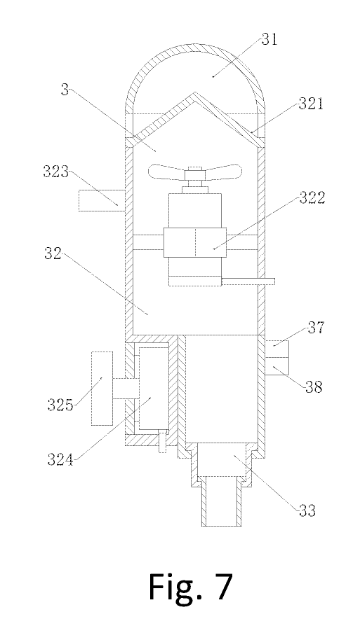

As shown in FIG. 7, the propulsion device 3 includes an upper cylinder 32 and a lower cylinder 33. The upper cylinder 32 is provided with a shaft 323 that is rotatably connected with the connecting hole 154. The top end of the upper cylinder 32 is provided with a filter 321. The inner cavity of the upper cylinder 32 is provided with a first motor 322 with a propeller. The first motor 322 is responsible for generating thrust. The bottom end of the upper cylinder 32 is provided with a second motor 324. The second motor 324 is driven to connect with the arc rack 155 by a gear. The tail of the upper cylinder 32 is moved upwardly and downwardly by the second motor 324, thereby changing the direction of the thrust.

The lower cylinder 33 is composed of a plurality of sleeves. The outside of the top end of the sleeves is provided with an outer convex ring. The inner side of the end of the sleeves is provided with an inner convex ring. The adjacent two sleeves are set to each other. The outer convex ring is in contact with the inner convex ring. The top end of the lower cylinder 33 is fixedly connected to the upper cylinder 33. The bottom end of the lower cylinder 33 is connected to the mounting plate 15 by an electric vat 34. The lower cylinder 33 is swung left and right that is driven by the electrical vet 34, thereby changing the direction of the thrust of the lower cylinder 33.

The top end of the upper cylinder 32 is provided with a protective cover 31 made of screen. The protective cover 31 prevents the damage caused by the collision between the filter 321 and rocks, etc.

The micro controller 36 electrically connects to the batter 35, the tension sensor 143, the first motor 322, the second motor 324, and the electric vat 34, respectively. The lower cylinder 33 is provided with a first gyroscope 37 and a water pressure sensor 38. The first gyroscope 37 and the water pressure sensor 38 are respectively electrically connected to the micro controller 36. The fastener 13 is provided with a second gyroscope electrically connected to the micro controller 36.

The micro controller 36 analyzes the signals detected from the tension sensor 143, the first gyroscope 37, the water pressure sensor 38, and the second gyroscope and generate control instructions, which control the movement of the first motor 322, the second motor 324, and the electrical vat 34. For example, if the tension sensor 143 detects that the human body rotates to the left with respect to the belt 1, the first motor 322 on the left will stop and the first motor 322 on the right will turn on, and the electrical vat 34 will pull the lower cylinder 33 inwardly to drive the propulsion device to rotate other components to the left. As another example, to prevent the diving depth of users exceeds the pre-set safety value, the water pressure 38 detects the diving depth of the users real-time. When the diving depth exceeds the pre-set value, the first motor 322 stops or the first motor 322 proceeds to run to change the thrust direction of the propulsion device to be upwards, which will pull the users until a depth that is within the safety value. As another example, when the second gyroscope detects that the human body tilts, the thrust direction of the propulsion device is adjusted by the movement of the second motor 324 and the electrical vat 34, until the inclination angle detected by the first gyroscope 37 coincides with the inclination angle of the human body.

A portable self-adjusting underwater booster with a life-saving device of the invention includes a belt, a life-saving device and a propulsion device. The belt fixes to the waist of the human body. The life-saving device and the propulsion device are connected to the belt. The life-saving device can pull the second pin to allow the gas to enter the airbag and generate buoyancy to drag the body out of the water. The belt is provided with a mounting plate. The propulsion device is installed on the mounting plate. Activities in multiple directions can be achieved by the driving of the second motor and the electrical vat. It can achieve the thrust that is exerted on the human body in multiple directions. The mounting plate and the belt are fixedly connected by the first pin. When emergency happens, the first pin can be pulled out to abandon the propulsion device. The arc plate in the inner side of the belt connects to the tension sensor, and transmits the signal of relative rotation to the micro controller. The second gyroscope detects the inclination angle of the human body. The first gyroscope is used to detect the rotation angle of the propulsion device relative to the human body. The water pressure sensor is used to detect the dive depth in order to avoid the danger caused by deep diving. The device has advantages of having simple and reasonable structure, being convenient to use, safe and reliable, high degree of intelligence with life-saving device. It effectively solves the problem regarding the existing underwater boosters not having life-saving function.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A portable self-adjusting underwater booster with a life-saving device, comprising: a belt 1; a life-saving device 2; and a propulsion device 3,
wherein the belt 1 includes a ring-shaped rear end 11 of the belt made of link boards, and a front end 12 of the belt made of straps; the front end 12 of the belt is fixedly connected to two ports of the rear end 11 of the belt; the front end 12 of the belt is provided with a fastener 13 that fastens the belt,
wherein the rear end 11 of the belt is symmetrically provided with a chute 113 at the inner side; the chute 113 is caught in an arc plate 14; the arc plate 14 is slidably connected to the chute 113; the chute 113 is provided with a tension sensor 143; the arc plate 14 is provided with a cam shaft 141 at the inner side; the cam shaft 141 is connected to the tension sensor 143 by a first spring 142; the rear end 11 of the belt is symmetrically provided with mounting plates 15 at left and right outer side; the rear end 11 of the belt is provided with a first bag 16 and a second bag 17,
wherein the mounting plate 15 is provided with a plurality of indentations 152 at the inner side; the rear end 11 of the belt is provided with a plurality of protrusions 111; the protrusion 111 is provided with a second spring 112 that extends into the indentation 152; the mounting plate 15 presses the second spring 112 so that the protrusion 111 is fixedly connected with the mounting plate 15 by a first pin 151; the mounting plate 15 is provided with a connecting hole 154 and an arc groove 150 at outer side; one inner side of the arc groove is provided with an arc rack 155; the other inner side of the arc groove 150 is provided with a rubber gasket 153 for collision prevention,
wherein the life-saving device 2 includes a compressed gas tank 22 disposed in the second bag, a valve 23, and an airbag 21 disposed in the inter layer of the rear end 11 of the belt; the airbag 21 is fixedly connected to the belt 1; the valve 23 includes a housing 220, an inlet 232, an outlet 233, a sealing partition 234, a slider 230 that is disposed in the cavity of the housing 230 and slidably connects to the housing 230, and a pipe 236 fixedly disposed on the slider 235; the inlet 232 is screwed to the compressed gas tank 22; the outlet 233 connects to the airbag 21; the pipe 236 is provided with a third spring 237; two ends of the third spring 237 are in contact with the slider 235 and the housing 230, respectively; the slider 235 presses the third spring 237 such that the slider 235 fastens the housing 230 by a second pin 231, and
wherein the propulsion device 3 includes an upper cylinder 32 and a lower cylinder 33; the upper cylinder 32 is provided with a shaft 323 that is rotatably connected with the connecting hole 154; the top end of the upper cylinder 32 is provided with a filter 321; the inner cavity of the upper cylinder 32 is provided with a first motor 322 with a propeller; the bottom end of the upper cylinder is provided with a second motor 324; the second motor 324 is driven to connect with the arc rack 155 by a gear 325; the lower cylinder 33 is composed of a plurality of sleeves; the top end of the lower cylinder 33 is fixedly connected to the upper cylinder 32; the bottom end of the lower cylinder 33 is connected to the mounting plate 15 by an electric vat 34.

2. The portable self-adjusting underwater booster with a life-saving device of claim 1, wherein the first pin 151 is arc-shaped.

3. The portable self-adjusting underwater booster with a life-saving device of claim 1, wherein the first bag 16 is provided with a battery 35 and a micro controller 36.

4. The portable self-adjusting underwater booster with a life-saving device of claim 1, wherein the micro controller 36 electrically connects to the batter 35, the tension sensor 143, the first motor 322, the second motor 324, and the electric vat 34, respectively.

5. The portable self-adjusting underwater booster with a life-saving device of claim 1, wherein the lower cylinder 33 is provided with a first gyroscope 37 and a water pressure sensor 38; and the first gyroscope 37 and the water pressure sensor 38 are respectively electrically connected to the micro controller 36.

6. The portable self-adjusting underwater booster with a life-saving device of claim 1, wherein the top end of the upper cylinder 32 is provided with a protective cover 31 made of screen.

7. The portable self-adjusting underwater booster with a life-saving device of claim 1, wherein the lower cylinder 33 is composed of a plurality of sleeves; the outside of the top end of the sleeves is provided with an outer convex ring; the inner side of the end of the sleeves is provided with an inner convex ring; the adjacent two sleeves are set to each other; and the outer convex ring is in contact with the inner convex ring.

8. The portable self-adjusting underwater booster with a life-saving device of claim 1, wherein the fastener 13 is provided with a second gyroscope electrically connected to the micro controller 36.

9. The portable self-adjusting underwater booster with a life-saving device of claim 1, wherein two ends of the electrical vat 34 are hinged to the bottom end of the lower cylinder 33 and the mounting plate 15, respectively.
